(19) United States
(12) Patent Application Publication
(10) Pub. No.: US 2003/0023754 A1
(43) Pub. Date: Jan. 30, 2003

(54) Method and system for adding real-time, interactive functionality to a web-page

(76) Inventors: Matthias Eichstadt, Sunnyvale, CA (US); Christopher Staib, Wilton, CT (US); David Shafron, Newyork, NY (US); Anil Pal, Sunnyvale, CA (US); T.S. Ramakrishan, Saratoga, CA (US)

Correspondence Address: Stroock & Stroock & Lavan, LLP, 180 Maiden Lane, New York, NY, 10038, US

(21) Appl. No.: 09/916,543

(22) Filed: Jul. 27, 2001

(51) Int. Cl. G06F 15/16

(52) U.S. Cl. 709/246; 709/219

(57) ABSTRACT

A method and system for adding real-time, interactive functionality to a web-page, e.g., a HTML document, that enables interaction between and among a plurality of users viewing the same web-page. Software stored on and operable in connection with a server computer comprises a server component and a client component. The server component provides general server functionality and proxy server functionality on the server. The client component is downloadable by the server for storage on and operation in connection with one or more client computer, and adds real-time, interactive functionality to a web-page.

### BACKGROUND OF THE INVENTION

1. Field of the Invention

This invention is directed to a method and system for adding real-time, interactive functionality to a web-page.

2. Background of the Invention

An Internet browser, such as Netscape Navigator or Microsoft Explorer, provides a well recognized interface between a user of the browser and the Internet. Using a browser, a user may, for example, request, receive and display web-pages, navigate from one Internet site to another, and launch applications (e.g., media (audio and/or video) players, applets, plug-ins, ActiveX controls, etc.). When received by a user's computer for display via the browser, a web-page has certain predefined content and functionality that is available only to that user. For example, if a user requests a web-page including a video clip, that video clip may be displayed only by the user's browser and viewed only on that user's computer. While the same web-page may be requested by different user's, the subsequent display of the web-page and viewing of the video clip by the various users having requested the web-page are independent of each other. It is currently not possible for two geographically separate clients to request the same web-page, simultaneously view the web-page and interact with each other via the web-page.

It is generally known that content may be added to a web-page by an Internet Service Provider (ISP) before the web-page is transmitted to a user. For example, banner advertisements may be added to a web-page. In fact, the same advertisement may be added to the same web-page requested by multiple users. However, each user still receives and views the web-page separately from the other users who requested to same web-page. Moreover, the added content does not provide the ability of one user to interact with another user having requested and received the same web-page.

It is thus desirable to provide a method and system for adding functionality to a web-page that permits multiple users to receive the same web-page and interact with each other.

### SUMMARY OF THE INVENTION

The present invention provides a method and system for adding real-time, interactive functionality to a web-page, e.g., a HTML document, that enables interaction between and among a plurality of users viewing the same web-page. The present invention is provided via software stored on and operable in connection with a server computer. A server component of the software provides general server functionality and proxy server functionality on the server. A client component of the software is downloadable by the server for storage on and operation in connection with one or more client computer, and adds real-time, interactive functionality to a web-page. The present invention may also be provided on a computer readable medium (e.g., floppy disk, CD-ROM, or other data storage and retrieval device) comprising computer code (i.e., software) for carrying out the functionality of the various embodiments of the present invention, as discussed in more detail herein.

The system of the present invention comprises a server computer connected to a network such as, for example, the Internet. Alternatively, the system may comprise a plurality of servers connected to each other and to the Internet. Software is stored on and operable in connection with the server. The software provides various functionality for the server, and also provides functionality to the client computer, as described in more detail below. The hardware configuration of the server, or plurality of servers, as the case may be, is not a defining feature or limitation of the present invention. The server(s) are preferably configured and operable so as to facilitate the functionality provided by the software of the present invention, as described in more detail below.

In a preferred embodiment, the software comprises a server component and a client component. The server component is stored on and operable in connection with the server and may comprise one or more software programs, including but not limited to, executable programs, databases, library files, scripts, and the like. The server component of the software provides general server functionality that enables users to set-up user accounts, manage sessions (a session being generally defined herein when one or more users request a web-page), and generally monitors the activity of clients during a session, receives data from each user's client component and transmits that user data to each user viewing the web-page (i.e., each user participating in a particular session). The server component of the software also provides proxy server functionality that receives user requests for a web-page, retrieves the web-page, parses the web-page, inserts the script code (or a reference or pointer to the script code), and transmits the modified web-page including the inserted script code to the one or more users who requested the web-page.

The client component of the software comprises script code that is incorporated into the requested web-page or HTML document and is stored on each client computer and operable in connection therewith. The script code may be written (i.e., coded) in JavaScript, VBScript, or in any other known or hereafter developed script language, as a routine matter of design choice. When a user requests a web-page via the server, the requested web-page may be stored on the server, or on another server. In either case, the server retrieves the web-page and transmits the requested web-page to the client computer. In accordance with an embodiment of the present invention, the server component of the software incorporates (either directly or by reference) script code into the requested web-page before that web-page is transmitted by the server to the client computer. That script code comprises the client component of the software and will add functionality to the web-page, as described in more detail below. The modified web-page is transmitted by the server to the client computer, and the script code is loaded into RAM on the client computer when the web-page is displayed by the client's Internet browser. In a preferred embodiment, the script code is not permanently stored on the client computer, but loaded into RAM only while the web-page is being viewed by the user (i.e., displayed by the browser). When the user closes the Internet browser window within which the web-page is displayed, or causes the browser to connect to a different Internet address (i.e., request a different web-page), the script code is erased from RAM and thus no longer available to the user's browser.

Prior to utilizing the present invention, a user must register or establish a user account on the server utilizing the server functionality of the server component of the software. Each user may enter certain user-specific data such as, for example, user id, password, attributes for drawing (e.g., line type and color), and web-pages to be accessed. Once that is done, the server transmits a data file such as a cookie, for example, for storage on the user's computer. A registered user may participate in a session, request, receive and view web-pages having the inventive script code incorporated therein, and utilize the functionality added to the web-page by the script code.

A user may request a web-page by selecting a hypertext link, providing an Internet address or url in an address window of their browser, or in other ways known in the art. The web-page request is received by a server, which obtains a copy of the web-page either from local storage (e.g., the server's hard-drive), or from another server or storage location. The server component of the present invention providing the proxy server functionality parses the web-page (i.e., the HTML code of the web-page) to determine its construct and to determine an appropriate location at which to insert the script code. For example, the server component may insert script code in the header structure of the web-page. Alternatively, the server component may add a reference (e.g., a subroutine call) or pointer (e.g., storage location) to the script code to the web-page. The added script code adds real-time, interactive functionality to the web-page within which the script code is incorporated. For example, the script code may provide functionality that permits a user to mark a web-page, that transmits the user's mark to the server, and that receives from the server marks made by other user's clients viewing the same web-page. The script code may also provide functionality that facilitates distance learning by enabling a teacher (i.e., a registered user) to point to and/or mark a web-page (which may comprise one or more pages from a text book in HTML format). The functionality of the present invention propagates that mark to all registered users participating in a session. Thus, a plurality of students (each a registered user) may simultaneously view a web-page and receive real-time instruction from a teacher over the Internet and without the need for specialized or expensive equipment. The present invention may also provide other real-time, interactive functionality to a web-page, as described in more detail herein, and as now known and hereafter developed; the type of functionality added to a web-page neither defining nor limiting the scope and spirit of the present invention.

In addition to adding real-time, interactive functionality to a web-page, the script code accounts and compensates for the computer hardware differences of the various users so that any changes, annotations, etc., made to a web-page by one user appear in the same place on the web-page for all users viewing the web-page in the same session. To accomplish that, the script code initially analyzes the web-page, and more specifically, the script code analyzes the underlying HTML web-page data, and breaks that underlying data into a plurality of groups. For example, the script code may first determine the number and location (using an x, y coordinate system, for example) of paragraphs in the document, then the number of sentences in each paragraph, words in each sentence, and letters in each word. The script may also identify and locate any non-text data provided in the web-page such as, for example, graphs, pictures, url links, video clips, etc. By carrying out the above-described analysis on each client computer, the web-page is broken into a plurality of discrete elements, with each element and the contents thereof being assigned a unique location and being separately identifiable by the script code. In essence, the script code constructs a tree of HTML tags that identify the various parts or elements of the web-page or HTML document. Each tag has a unique identifier. In that way, when a first user circles the first word in the first sentence of the first paragraph, the script code can identify the location on the web-page for that first word using the unique identifier previously assigned to the node for that word. The script code can then transmit that unique identifier to the other client computers via the server, with the script code on the receiving client computers locating the same first word using the previously constructed tree and unique identifiers. In that manner, the same word circled by the first user is simultaneously circled on every other user's display and web-page.

As used herein, the term “client” generally refers to any of a computer that connects to a network and that exchanges (transmits and receives) data with a server, a user of that computer, and any software that is used on a client computer to exchange data with software running on a server (e.g., an e-mail client). As used herein, the term “content” means, by way of non-limiting example, text, numeric, photo, video, graphics (still and animated), audio, music, combined audio and video, streaming media, any combination of the foregoing, various other data known to a person of ordinary skill in the art, and all other types of data that may comprise a web-page or HTML document.

The invention accordingly comprises the features of construction, combination of elements, and arrangement of parts which will be exemplified in the disclosure herein, and the scope of the invention will be indicated in the claims.

### BRIEF DESCRIPTION OF THE DRAWINGS

In the drawing figures, which are not to scale, and which are merely illustrative, and wherein like reference numerals depict like elements throughout the several views:

FIG. 1 is a schematic block diagram depicting a server and a plurality of client computers connected to a network in accordance with an embodiment of the present invention;

FIG. 2 is a block diagram depicting the various elements of an exemplary web-page;

FIGS. 3A and 3B depict exemplary web-pages displayed by the browsers of two users during a session in accordance with an embodiment of the present invention;

FIG. 4 is a flow diagram of certain steps performed by the server component of the software in accordance with an embodiment of the present invention; and

FIG. 5 is a flow diagram of certain steps performed by the client component of the software in accordance with an embodiment of the present invention.

### DETAILED DESCRIPTION OF THE PREFERRED EMBODIMENTS

The present invention is directed to a method and system for adding real-time, interactive functionality to a web-page or HTML document. Certain embodiments of the present invention will now be discussed in detail and with reference to the drawings. Although the present invention is network-based and preferably utilizes the Internet (including the World-Wide Web), one skilled in the art will recognize that the present invention may utilize any type of network, including, by way of non-limiting example, a LAN, WAN, intranet, land-based, cellular, etc., and using any type of computing device

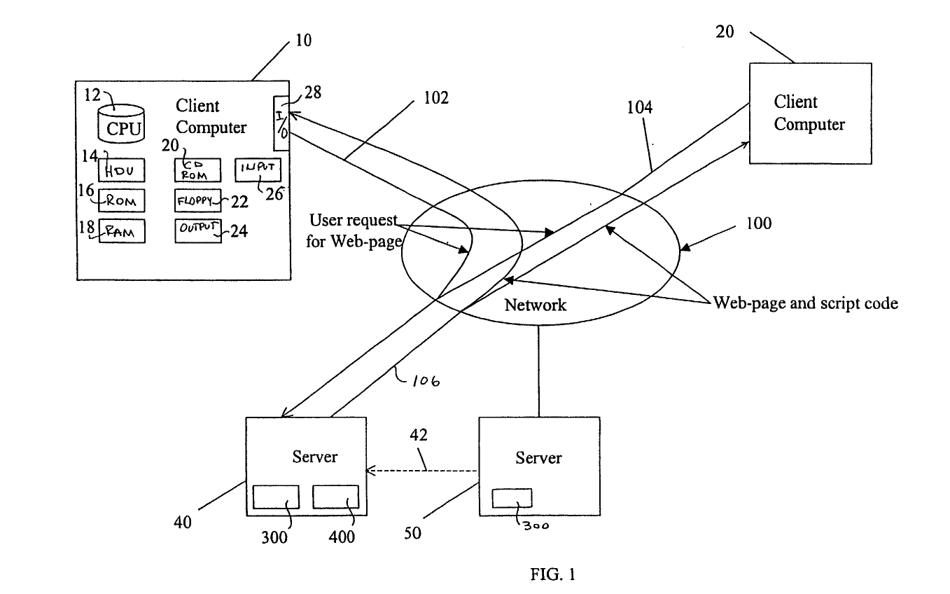

As used herein, the terms “computer” and “computing device” are intended to be construed broadly, and in a non-limiting manner, and to include, without limitation and by way of illustration only, any electronic device capable of receiving input, processing, storing and providing output, typically as digital data, and that is connectable to a network such as, for example, the Internet. A computer may be a computer of any style, size, and configuration including, without limitation, a server, workstation, desktop, laptop, Internet appliance, notebook, personal digital assistant (PDA), etc. A computer such as depicted in FIG. 1 and generally designated as 10, typically includes the following components: a central processing unit (CPU or processor) 12 operable in connection with general purpose software (e.g., operating system, Internet browser, application programs (word processing, spreadsheet, etc.)), a hard-disk unit (HDU) 14, permanent memory (e.g., ROM) 16, temporary memory (e.g., RAM) 18, one or more removable disk units (e.g., CD-ROM, floppy drive, etc.) 20, 22, an input device (e.g., keyboard, mouse, trackball, etc.) 26, an output device (e.g., monitor or display) 24, and I/O device (e.g., modem) 28. It is known to a person skilled in the art that a computer may comprise some or all of those components, in addition to components not listed.

The terms “communicate” and “transmit” (and variations thereof) are used interchangeably herein to refer to the exchange of data (typically digital data) within a single computer (e.g., between and among any of a script, an application, a control, etc.) and/or between one or more computers.

Referring now to the drawings, and with initial reference to FIG. 1, the system of the present invention comprises a server 40 having special purpose software (discussed in more detail below) installed thereon and operable in connection therewith. The server 40 is connected or connectable to a network 100 such as the Internet, and “located” at a predetermined Internet address or url. That is, a user may enter that predetermined Internet address in their browser and cause their computer to connect to the server 40 via the Internet 100. The system may comprise a single server 40 as depicted in FIG. 1, or multiple servers, as a routine matter of design choice, to provide the functionality of the present invention. The number and configuration of the servers of the inventive system is transparent to the clients and does not define or limit the scope or spirit of the present invention.

General purpose software (e.g., operating system, communication, security, database, etc.) and special purpose software (defined in more detail below) are installed on and operable in connection with the server 40. The general purpose software facilitates overall operation of the server 40, and may comprise the operating system and other applications necessary or useful in providing a server, as is generally known in the art.

The special purpose software comprises a server component and a client component. The server component is stored on and operable in connection with the server and may comprise one or more software programs, including but not limited to, executable programs, databases, library files, scripts, and the like. The server component of the software provides general server functionality that enables users to set-up user accounts, manages sessions (a session being generally defined herein when one or more users request a web-page), monitors the activity of users viewing a web-page, receives data from each user's client component as each user points on and/or mark the web-page and transmits that user data to each user viewing the web-page (i.e., each user participating in a particular session).

The general server functionality facilitates and manages all aspects of a session, including setting up user accounts, authenticating each user before permitting a user to enter a session, disconnecting a user if that user's connection to the server is inactive for a predetermined period of time, and forwarding all data received from each user in a session to all other users in the session. To set up a new user account, the user typically responds to certain questions provided by the server 40 (provided by software on the server). For example, the user may be queried to enter a user id, password, list of web-pages that the user desires to access, drawing preferences (e.g., line color and type), and other user-identifying parameters. That data is stored by the server in a user account database which is used to authenticate that user during attempts by that user to join or initiate a session. When a user account is established, the server transmits a data file (e.g., a cookie) to the user's computer for storage thereon. The cookie includes certain data regarding that user that is compared to the data stored in the user account database when the user attempts to initiate or join a session. Thus, when a user joins a session, the cookie is transmitted to the server 40 and the user is authorized to join the session (if appropriate). The general server functionality also monitors each user's activity during a session, and may communicate that activity to all users, or to selected users (or even a selected user) during a session. For example, if a new user joins a session late, all other users currently participating in that session may be notified by the server (the general server functionality). Similarly, when a user leaves a session, all other users may be notified. Notification may be by way of instant messaging, via a status window provided during a session, or in other ways.

The general server functionality also receives and forwards to all participants in a session data received from each participant. As each user points to or draws on the web-page, whatever was pointed to/drawn appears on all other users web-pages, in real-time.

The server component of the software also provides proxy server functionality that receives user requests for a web-page, retrieves the requested web-page, parses the web-page to determine a suitable location to insert the script code, inserts the script code or a reference or pointer to the script code, and transmits the modified web-page to the user. Preferably, the script code is added to the header structure of the web-page. However, a web-page may already have script code as part of its header structure. The proxy server functionality can determine this during parsing of the web-page. It is undesirable to modify any script already provided with the web-page because that may undesirably affect the web-page. For example, the header structure of a web-page may include initialization script that sets-up the look of the web-page, launches any associated applications, opens any associated files, etc. Any script code added to the web-page should not modify or affect the initialization of the web-page as defined by any script already provided in the web-page. In accordance with an embodiment of the present invention, the proxy server functionality inserts script code at an appropriate location in the header structure so as to not affect any script already provided therein. Preferably, that location is at or near the end of any initialization script in the header structure of the web-page, and before the web-page initialization is completed. Thus, when the web-page is loaded on a client's computer, the initialization script originally provided with the web-page is executed, followed by execution of the inventive script code. In that manner, real-time, interactive functionality may be added to a web-page.

Each client computer 10, 20 includes general purpose software (e.g., operating system, communication, word processing, e-mail, database, etc.), and hardware components generally known to a person of skill in the art (e.g., processor, memory (RAM, ROM), hard-drive, display, communications hardware (e.g., internal modem), mouse or other cursor control device, and keyboard, as depicted in FIG. 1). Preferably, each client computer has installed thereon Internet browser software (e.g., Netscape Navigator®, Microsoft Explorer®) that facilitates connection of the client computer to the Internet and communication between the client computer and one or more other computers (servers and clients) also connected to the Internet. The browser software provides at least one browser window for viewing and displaying web-pages received by the client's computer via the network 100 (e.g., from the server 40). The client computer 10 may also include various other software and hardware components, as a routine matter of design choice, the present invention not being limited in scope or spirit by the configuration of the client computer 10. The client computers 10, 20 are generally considered to be equivalent in terms of functionality, and unless expressly stated otherwise, reference to one client computer 10 shall include all client computers.

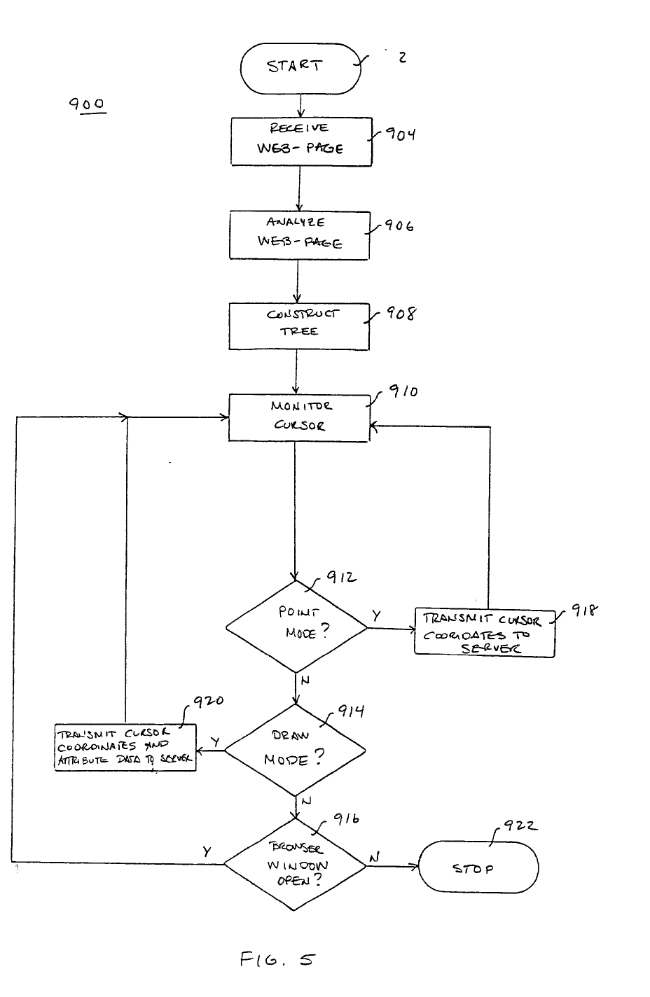

The client component of the special purpose software of the present invention comprises script code added to the web-page by the proxy server functionality, as described above. When a user requests a web-page from the server 40, that user's cookie is communicated to the server 40. If that user is authorized to view the requested web-page (as determined by the general server functionality by comparing the cookie data with the data stored in the user account database), that user is permitted to join the session. Upon receipt of the requested web-page, step 904 in FIG. 5, the script code is loaded into RAM 18 on each client's computer 10 when the web-page is displayed by the user's Internet browser. When the script code is initialized, which occurs when the web-page is loaded into RAM on the client computer and essentially simultaneously with the display of the web-page by the browser, the script code analyzes the structure of the web-page, step 906, and builds a tree of HTML tags to identify the various parts of the web-page, step 908. That tree may be stored in a file such as, for example, a database file. The script code then monitors the user's cursor movement, step 910, determines whether the user is operating in point mode, step 912, or, draw mode, step 914. If operating in point mode, the script code transmits the user's cursor coordinates to the server, step 918. If operating in draw mode, the script code transmits the user's cursor coordinates and attribute data to the server, step 920. The script code also monitors the status of the Internet browser window, step 916. If the browser window is opened, the script code continues to monitor the user's cursor movements, step 910. If the browser window is closed, the script code terminates, step 922.

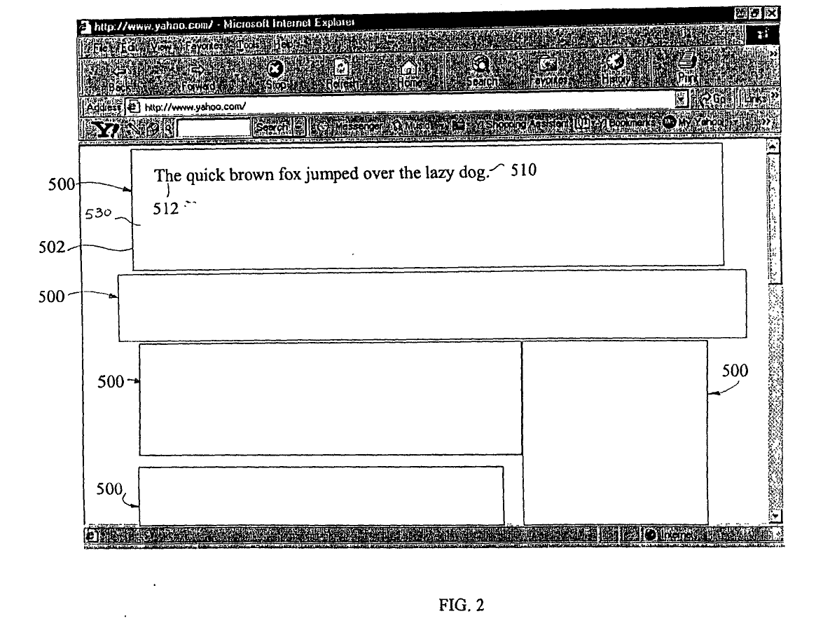

Referring to FIG. 2, a web-page 300 is generally depicted in block diagram form that includes a plurality of elements 500. An element 500 may be any part of a web-page, including, by way of non-limiting example, a picture, a paragraph, a sentence, a word, a banner add, a hypertext link, a video clip, an audio clip, any numerical or textual data, etc. Each element 500 is identified and identifiable by an HTML tag provided in the HTML code that defines the web-page 300 (see, e.g., FIG. 1). The script code analyzes the web-page 300 to locate each element 500 and assigns a unique identifier to each HTML tag. In so doing, the script code constructs a tree of unique HTML tags according to the interrelation between and among the various elements 500 and stores that information in a database file. For example, the script code may identify a first paragraph 530 in FIG. 2, and assign a unique identifier to the HTML tag for that element 500. The script code may also identify a first sentence 510 in that first paragraph 530, and assign a unique identifier to the HTML tag for that sentence 510, and relate that sentence 510 (and HTML tag) to the first paragraph 530. The script code may than identify a first word 512 in the first sentence 510 of the first paragraph 530, assign a unique identifier to the HTML tag for that word 512, and relate that word 512 to that sentence 510 to that paragraph 530. In that manner, the script code evaluates the entire web-page and constructs a tree of unique identifier for the HTML tags for all elements of the web-page 300 to enable the script code to locate the various elements 500 that make-up the web-page 300. Each element 500 is also positioned on the web-page by a bounding rectangle 502 defined by the script code. The rectangle 502 provides a reference point (e.g., lower left corner) from which the various parts of the element 500 may be located with regard to the web-page. Each element 500 can then be precisely located by the script code so that any actions by the user (e.g., point and/or draw actions) to a particular element 500 may be communicated by the script code to the server and to all other participants in the session. Since each user is viewing the same web-page, and the script code added to the web-page is communicated to and stored on and operable in connection with each client computer, real-time, interactive functionality is added to the web-page that enables each user to individually point, mark, draw, etc., to or on a particular element 500 of the web-page, with that same element being pointed to, marked, drawn on, etc., at the same time on every other user's web-page.

In an embodiment, the script code may enable a user to switch between a point mode and a draw mode. In point mode, a user may direct the cursor to any part of the web-page and that action will be communicated, in real-time, to all other users viewing the same web-page and participating in the session. The script code intercepts the coordinates of the cursor and communicates that coordinate data to the server (the general server functionality), which communicates the data to all other participants in the session. That feature may be useful in an instructional application where one user is an instructor or leader and guides the other users through information on the web-page. In draw mode, a user may draw, mark, underline, highlight, etc., any part of the web-page, with that action also being communicated, in real-time, to all other users viewing the same web-page and participating in the session.

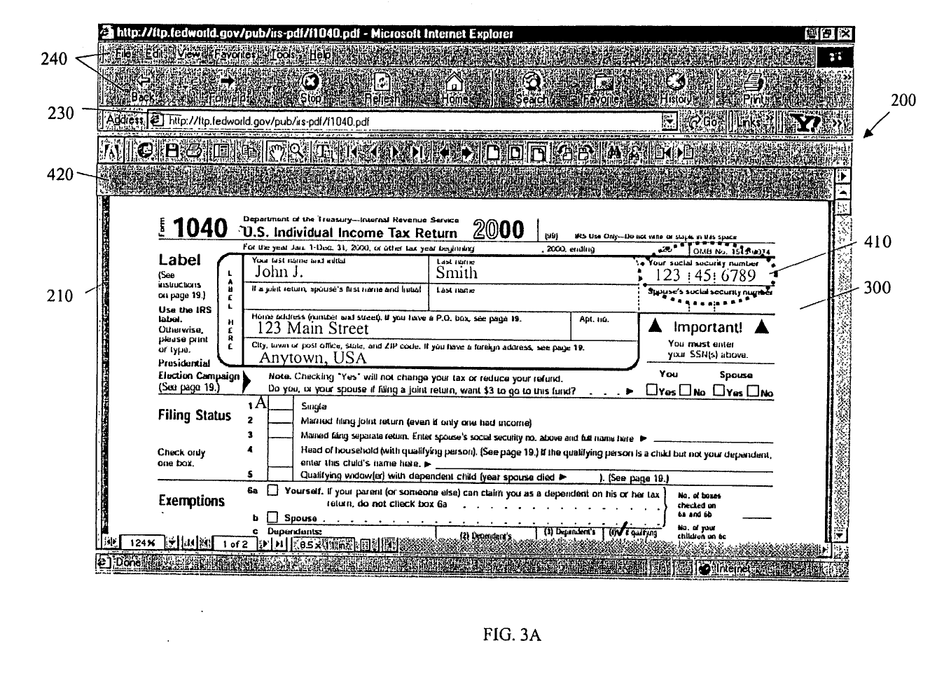

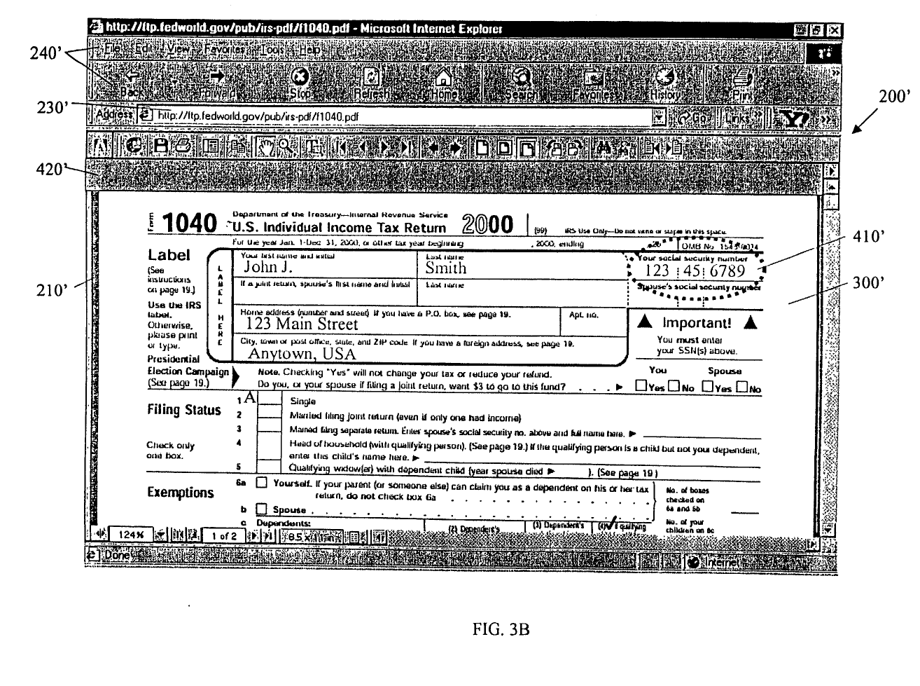

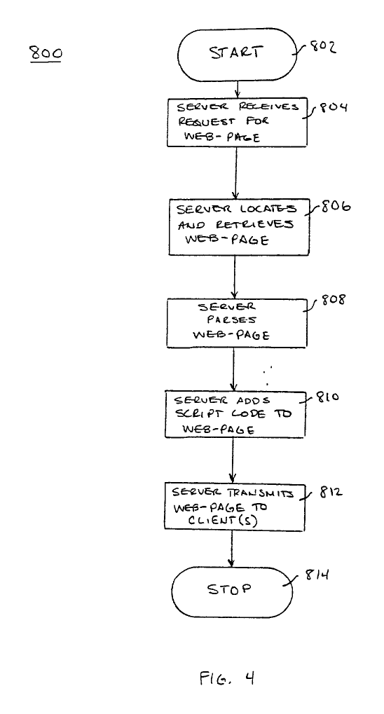

With reference again to FIG. 1, the functionality of the present invention is provided in part, at least in the first instance, by the server 40. In an embodiment of the present invention, the script code 400 and web-page 300 are stored in a data storage device (e.g., hard-drive, drive, optical disk drive, ROM, etc.) of the server 40. Alternatively, the web-page 300 may be stored on another sever 50, and retrieved by the server 40, as indicated by dashed-line 42. In response to a request from a user, the server 40 retrieves the web-page 300, parses the web-page to determine its construct and an appropriate location to add the script code, and downloads the modified web-page 300 to the client computer 10. The user request for a web-page 300 may be communicated when the user selects a hypertext link on another web-page, for example, or when the user enters a predetermined Internet address in the browser window 230 (see, e.g., FIG. 3A). When the server 40 receives that request, step 804 in FIG. 4, the proxy server functionality locates and retrieves the web-page 300, step 806, parses the web-page 300 and adds the script code 400 to the web-page, steps 808 and 810, and communicates the modified web-page to the client computer 10, step 812. Upon receipt by the client computer 10 of the modified web-page 300, the web-page 300 is displayed in the browser window 210 (see, e.g., FIG. 3A) and the script code 400 is loaded into RAM 18 on the client computer 10. The script code 400 is thereafter operable in connection with the web-page and browser and provides the functionality of the present invention, as described in more detail herein, while the user is viewing the web-page 300. When the user closes the browser or browser window 210 within which the web-page 300 is displayed, the script code 400 is erased from RAM 18. Similarly, when the user causes the browser to navigate to another web-site or url, and the web-page 300 is no longer displayed in the browser window 210, the script code 400 is erased from RAM 18.

The script code 400 also coordinates each user's display so that one user's annotation, revision, marking, etc., of a web-page appear in the same place on the web-page displayed on the other client computers, regardless on any differences in the various client computer hardware. The challenge here is to map point and draw coordinates made by one user between different browsers and to accommodate different display resolutions, font size and browser window sizes. In accordance with an embodiment of the present invention, the script code 400 utilizes a two-step approach. First, the script code 400 analyzes or parses the web-page 300. The result of the parsing process is a parse tree (a DOM tree) where the nodes of the tree correspond to individual elements 500 or HTML tag in the web-page, such as a paragraph of text, a word in a paragraph, a url link, an image and so on. The script code 400 applies a deterministic algorithm to assign unique identifiers to each node or HTML tag; the identifiers being unique within one web-page. The algorithm applied by the script code 400 assigns the identifiers in such a way that the elements of the same document or web page are assigned the same identifier for each of the client computers, even if the web-page is being displayed using different browsers and or on different computer configurations.

Thus, the script code 400 of the present invention enables easy and reliable addressing of the various parts of a web-page. When a first user points to a word on a web-page, the unique identifier (with respect to that particular web-page) of the word will be transmitted by the script code 400 through the server 40 to all users participating in the active session for that web-page. That identifier is received by each participating client computer and interpreted by the script code 400 on those computers to identify and locate the word to which the first user pointed.

The algorithm utilized by the script code 400 of the present invention limits the precision of the drawing application to the smallest elements in the document (e.g., paragraph, word, image, etc.). In order to increase the precision of the pointing (and drawing) positions, the present invention utilizes a relative positioning mechanism. First, the script code 400 determines which element is being drawn on or pointed to by comparing the cursor position against a bounding rectangle 502 (see, e.g., FIG. 2) of the element in question. Then, the script code 400 determines a reference point for relative measurement. The reference point for an element may be the lower left hand corner of the bounding rectangle 502 of the element, for example. The script code 400 then subtracts the reference point from the cursor position to yield relative coordinates for the current drawing position. The script code 400 transmits the unique element identifier for the particular element along with the relative coordinates to the server 40, which transmits that data to the various users participating in the session. Each user's script code 400 that receives the element identifier and relative coordinates, and applies a reverse computation to locate and position the cursor on the viewer's web-page.

For example, and continuing with the tax consultant example provided above, if a user desires to view his/her tax forms, the user may select a hypertext link in a web-page that provides a link to another web-page 300 that is the tax forms. By selecting that hypertext link, the user thus causes the tax forms (the web-page) to be transmitted to the user's computer for display in the browser window. When the tax forms web-page is transmitted by the server 40 to the user's computer 10 for display by the user's Internet browser, the script code 400 is added to the web-page 300. When the user navigates to another web-page (other than the tax forms web-page), the instance of the script code 400 stored in RAM 22 when the tax forms web-page was transmitted by the server 40 to the user's computer 10 is erased from RAM 22 and is no longer available to the user's browser. In that way, the script code 400 is provided only in connection with a predetermined web-page 300.

An alternative embodiment of the present invention also contemplates the script code 400 being downloaded by the server 40 for permanent storage on the client computer 10, e.g., on the hard-disk unit 14, and locally loaded into RAM 18 when the user requests and receives a web-page 300 from the server and views the document 300 in the browser window 210. In that embodiment, the script code 400 is downloaded by the server 40 to each client's computer prior to or simultaneously with the download of the web-page 300. Instead of only being stored in RAM 18, the script code 400 is also stored on each client's hard-disk unit 14. When the user navigates to another url, closes the browser, etc., the script code 400 is not erased form the client hard-disk unit 14, but merely erased from RAM 14.

The dashed line 42 in FIG. 1 indicates that the web-page 300 may not be stored on the server 40 to which the user initially connects. For example, a user may initially cause the browser to navigate to a first web-site and connect to server 40. The web-page 300 may be located at a different web-site and server 50. From the first web-site, the user may select a url causing the user's browser to navigate to the different web-site and retrieve the web-page 300 from server 50 through server 40. The proxy server functionality of the software on server 40 still parses the web-page 300 and adds the script code 400, as described in detail above.

Referring next to FIGS. 3A and 3B, and with continued reference to FIG. 1, an illustrative, non-limiting example of the functionality and operation of the present invention will now be discussed. The view in FIG. 3A is of a browser interface 200 of a first client computer, and in FIG. 3B, of a browser interface 200′ of a second client computer 20. The browser interface 200, 200′ on each client computer provides a plurality of browser toolbars 240, 240′, and an address window 230, 230′ in which users may enter an Internet address or url to cause the browser to navigate to a desired Internet site or web-site. The browser interface 200 also includes a browser window 210, 210′ within which a web-page 300, 300′ may be displayed. The script code 400 may provide a toolbar 420, 420′ that may contain a dialog box and interface components such as buttons, checkboxes and other controls. Such a toolbar 420, 420′ may enable a user to join a session using a username/password, change the shape and color of his drawing pen, and change the appearance of the pointing icon. Other features and functionality may be provided via the toolbar, the forgoing being provided as illustrative, non-limiting examples.

For example, and continuing with the tax consultant example provided above, if a user desires to view his/her tax forms, the user may select a hypertext link in a web-page that provides a link to another web-page 300 that is the tax forms. By selecting that hypertext link, the user thus causes the tax forms (the web-page) to be transmitted to the user's computer for display in the browser window. When the tax forms web-page is transmitted by the server 40 to the user's computer 10 for display by the user's Internet browser, the script code 400 is added to the web-page 300. When the user navigates to another web-page (other than the tax forms web-page), the instance of the script code 400 stored in RAM 22 when the tax forms web-page was transmitted by the server 40 to the user's computer 10 is erased from RAM 22 and is no longer available to the user's browser. In that way, the script code 400 is provided only in connection with a predetermined web-page 300.

Thus, while there have been shown and described and pointed out fundamental novel features of the invention as applied to preferred embodiments thereof, it will be understood that various omissions and substitutions and changes in the form and details of the disclosed invention may be made by those skilled in the art without departing from the spirit of the invention. It is the intention, therefore, to be limited only as indicated by the scope of the claims appended hereto.

What is claimed is:

1. A method of adding interactive functionality to a web-page comprising:
(a) receiving a request for the web-page from a user;
(b) retrieving the requested web-page;
(c) adding script code to the requested web-page to add interactive functionality to the web-page; and
(d) transmitting the requested web-page and script code to the user.

2. A method as recited by claim 1, further comprising:
receiving a request for the web-page from another user;
retrieving the requested web-page;
adding script code to the requested web-page to add interactive functionality to the web-page; and
transmitting the requested web-page and script code to the another user, the script code enabling the user and the another user to interact with each other while viewing the web-page.

3. A method as recited by claim 1, wherein said step (c) comprises parsing the web-page to determine an appropriate location to add the script code.

4. A method as recited by claim 3, wherein the web-page includes a header and wherein the appropriate location is in the header.

5. A method as recited by claim 2, wherein said step (c) comprises parsing the web-page to determine an appropriate location to add the script code.

6. A method as recited by claim 5, wherein the web-page includes a header and wherein the appropriate location is in the header.

7. A method as recited by claim 1, wherein said step (a) comprises:
receiving a data file from the user including user account data and web-page identification data; and
determining if the user is authorized to access the requested web-page.

8. A method as recited by claim 2, wherein said receiving step comprises:
receiving a data file from the another user including user account data and web-page identification data; and
determining if the another user is authorized to access the requested web-page.

9. A method as recited by claim 2, wherein each of the user and the another user have a computer having a display on which the web-page is displayed, each user's computer having a cursor control device to control movement of a cursor on each user's display, and wherein each user's cursor is unique and appears on the other user's web-page, and wherein the web-page includes a plurality of elements, and wherein the script code added to each user's web-page adds interactive functionality to the web page by:
assigning a unique identifier to each element in the web-page;
storing in memory a tree of each unique identifier;
determining a user's cursor position by intercepting cursor coordinates to provide cursor coordinate data as the users causes the cursor to move over the web-page;
comparing the cursor coordinate data with the tree to determine the element over which the user's cursor is positioned; and
transmitting the cursor coordinate data and unique identifier for the element over which the user's cursor is positioned to the other user.

10. A method as recited by claim 9, wherein the script code added to each user's web-page adds interactive functionality to the web page by:
receiving the cursor coordinate data and unique identifier from the other user;
comparing the cursor coordinate data and unique identifier with the tree to determine the element over which to position the other user's cursor; and
positioning the other user's cursor over the element.

11. A method of facilitating and monitoring interaction between a first user viewing a web-page and a second user viewing the web-page, said method comprising:
(a) providing the web-page to each of the first and second user, the web-page having script code to provide interactive functionality to the web-page;
(b) receiving cursor data from one of the first and second user; and
(c) transmitting the received cursor data to the other one of the first and second user.

12. A method as recited by claim 11, wherein the cursor data is one of point data and draw data.

13. A method as recited by claim 11, further comprising transmitting to each of the first and second user, an identity for the other one of the first and second user.

14. A method as recited by claim 11, wherein the first and second users are participants in a session, said method further comprising:
determining if a new user has joined the session; and
transmitting to each user participating in the session, an identity for the new user.

15. A method as recited by claim 11, wherein the first and second users are participants in a session, said method further comprising:
determining if a user has left the session; and
transmitting to each user participating in the session, an identity for the user that has left the session.

16. A system for adding interactive functionality to a web-page requested by a first user having a computer connectable to the Internet using an Internet browser stored on a data storage device of the first user's computer, the Internet browser enabling the first user to cause the computer to establish a connection to the Internet and to request and receive web-pages, said system comprising:
a server having a processor, the first user computer being selectively connectable to said server using the Internet browser, said processor being operable in connection with software loaded on the server for receiving a request from the first user for the web-page, said processor further being operable in connection with the software for retrieving the requested web-page and adding script code to the requested web-page to add interactive functionality to the web-page, said processor further being operable in connection with the software for transmitting the requested web-page and added script code to the first user's computer.

17. A system as recited by claim 16, wherein said processor is further operable in connection with the software on said server for receiving a request for the web-page from a second user having a computer connectable to the Internet using an Internet browser stored on a data storage device of the second user's computer, the Internet browser enabling the second user to cause the computer to establish a connection to the Internet and to request and receive web-pages, said processor is further operable in connection with the software on said server for retrieving the requested web-page, said processor further being operable in connection with the software for retrieving the requested web-page and adding script code to the requested web-page to add interactive functionality to the web-page, said processor is further operable in connection with the software on said server for transmitting the requested web-page and script code to the second user's computer, the script code enabling the first user and the second user to interact with each other while viewing the web-page.

18. A system as recited by claim 16, wherein said processor is further operable in connection with the software for parsing the web-page to determine an appropriate location to add the script code.

19. A system as recited by claim 17, wherein said processor is further operable in connection with the software for parsing the web-page to determine an appropriate location to add the script code.

20. A system as recited by claim 16, wherein said processor is further operable in connection with the software for receiving a data file from the first user including first user account data and web-page identification data, and wherein said processor is further operable in connection with the software for determining if the first user is authorized to access the requested web-page.

21. A system as recited by claim 17, wherein said processor is further operable in connection with the software for receiving a data file from the second user including second user account data and web-page identification data, wherein said processor is further operable in connection with the software for determining if the second user is authorized to access the requested web-page.

22. A system as recited by claim 17, wherein each of the first and second user's computer has a cursor control device to control movement of a cursor on a display of each of the first and second user's computer, and wherein each of the first and second user's cursor is unique and appears on the other display of the other user's computer, and wherein the web-page includes a plurality of elements, wherein said processor is further operable in connection with the software for adding interactive functionality to the web page by adding script code to the web-page for assigning a unique identifier to each element in the web-page, storing in memory a tree of each unique identifier, determining a cursor position for each of the first and second user's cursor by intercepting cursor coordinates to provide cursor coordinate data as each of the first and second user causes their cursor to move over the web-page, comparing the cursor coordinate data with the tree to determine the element over which each of the first and second user's cursor is positioned, and transmitting the cursor coordinate data and unique identifier for the element over which each of the first and second user's cursor is positioned to the other user.

23. A system as recited by claim 22, wherein said processor is further operable in connection with the software for adding interactive functionality to the web page by adding script code to the web-page for receiving the cursor coordinate data and unique identifier from the other user, comparing the cursor coordinate data and unique identifier with the tree to determine the element over which to position the other user's cursor, and positioning the other user's cursor over the element.

24. A system for facilitating and monitoring interaction between a first user viewing a web-page and a second user viewing the web-page, said system comprising:
a server having a processor operable in connection with software loaded on the server for providing the web-page to each of the first and second user, the web-page having script code to provide interactive functionality to the web-page, said processor being further operable in connection with the software for receiving cursor data from one of the first and second user, said processor being further operable in connection with the software for transmitting the received cursor data to the other one of the first and second user.

25. The system as recited by claim 24, wherein the cursor data is one of point data and draw data.

26. The system as recited by claim 24, wherein said processor is further operable in connection with software for transmitting to each of the first and second user, an identity for the other one of the first and second user.

27. A system as recited by claim 24, wherein the first and second users are participants in a session, said processor being further operable in connection with software for determining if a new user has joined the session, and transmitting to each user participating in the session, an identity for the new user.

28. A system as recited by claim 24, wherein the first and second users are participants in a session, said processor being further operable in connection with software for determining if a user has left the session, and transmitting to each user participating in the session, an identity for the user that has left the session.

29. A computer readable medium comprising computer code for instructing one or more processors to add interactive functionality to a web-page by:
(a) receiving a request for the web-page from a user;
(b) retrieving the requested web-page;
(c) adding script code to the requested web-page to add interactive functionality to the web-page; and
(d) transmitting the requested web-page and script code to the user.

30. A computer readable medium as recited by claim 29, further comprising computer code for instructing one or more processors to add interactive functionality to a web-page by:
(e) receiving a request for the web-page from another user;
(f) retrieving the requested web-page;
(g) adding script code to the requested web-page to add interactive functionality to the web-page; and
(h) transmitting the requested web-page and script code to the another user, the script code enabling the user and the another user to interact with each other while viewing the web-page.

31. A computer readable medium comprising computer code for instructing one or more processors to facilitate and monitor interaction between a first user viewing a web-page and a second user viewing the same web-page by:
(a) providing the web-page to each of the first and second user, the web-page having script code to provide interactive functionality to the web-page;
(b) receiving cursor data from one of the first and second user; and
(c) transmitting the received cursor data to the other one of the first and second user.
